(19) United States
(12) Patent Application Publication
(10) Pub. No.: US 2025/0336272 A1
(43) Pub. Date: Oct. 30, 2025

(54) METHOD, DEVICE AND COMPUTER PROGRAM FOR CONTEXTUAL ADAPTATION OF PHYGITAL GAMES

(71) Applicant: FDJ GAMING SOLUTIONS FRANCE, BOULOGNE-BILLANCOURT (FR)

(72) Inventors: Eric MEYNIEUX, VENTABREN (FR); Rémi THEYS, PUYRICARD (FR); Olivier HUGUENIN, VILLIERS SAINT FREDERIC (FR)

(21) Appl. No.: 18/701,857

(22) PCT Filed: Oct. 17, 2022
(86) PCT No.: PCT/FR2022/051955

§ 371 Date: Sep. 18, 2024

(30) Foreign Application Priority Data
Oct. 22, 2021 (FR) 2111258

(51) Int. Cl. G07F 17/32; A63F 3/06

(52) U.S. Cl. CPC G07F 17/3267; A63F 3/0665; G07F 17/329

(57) ABSTRACT

The invention relates to the contextual adaptation of games in a game system comprising a data processing device and a range of physical game cards associated with a main game, each game card comprising a contextual element associated with the main game, at least two distinct cards from the range of cards comprising two distinct contextual elements and at least two distinct cards from the range of cards comprising the same contextual element. For a card from the range of cards, an additional game is identified depending on an indication of the card. Access to this additional game is granted to a holder of this card by adapting, according to an obtained contextual element, the identified additional game, the contextualised additional game being specific to the obtained contextual element.

The invention relates to the field of phygital games comprising participation in initial physical scratchcard games followed by additional digital games such as interactive games or instant games.

Scratchcard games generally use a medium carrying result information, the latter being accessible after scratching the game area, that is to say after removing a mask. These media are typically in the form of cards sold in points of sale of a retailer network or vending machines. Generally, each card is identified in a unique way by a so-called logistical identifier. The logistical identifier is clearly readable on the front and/or on the back of the card, in the form of a number or of a barcode.

The result of a scratchcard game may be a losing result or a winning result, a winning result being able to indicate a win. In the case of phygital games, a result may make it possible to participate in a second digital game (or additional game), for example a game of the double or quits type. The digital game is proposed to players depending on the winning or losing nature of their card and where applicable their winning rank. Thus, a digital game may be proposed, for example, to all of the players having a losing card or to all of the players having a winning card except at the highest rank. The participation in such a second game may take place on personal equipment of the player (such as a smartphone, a tablet or a computer) or on a game terminal provided to players in certain points of sale. In order to make it possible to manage scratchcard games, each card carries a validation code that, combined with the logistical identifier, makes it possible to query a central system to know if the card is winning or not and which result is associated with it. The validation code is printed in a masked area, in the form of barcodes and/or of a number.

Although the phygital games offer a new experience to players, it remains limited. The object of the present invention is to enhance and customise the player experience without fundamentally modifying the principles of the game.

### DISCLOSURE OF THE INVENTION

For this purpose, the invention proposes a method, a device, a system and computer program for contextual adaptation of phygital games.

Thus, a method is proposed for contextual adaptation of games in a game system comprising at least one data processing device and a range of physical game cards associated with a main game, each game card comprising a contextual element associated with the main game, at least two distinct cards from the range of cards comprising two distinct contextual elements and at least two distinct cards from the range of cards comprising the same contextual element, the method being implemented in the at least one device and comprising, for at least one card from the range of cards,
identifying an additional game depending on at least one indication of said at least one card;
authorising access to said additional game to a holder of said at least one card;
obtaining the contextual element of said at least one card; and
adapting, according to said obtained contextual element, said identified additional game, said contextualised additional game being specific to said obtained contextual element.

The method according to the invention thus makes it possible to contextually adapt additional digital games to scratchcard games. Contextual adaptation in particular means the adaptation of the universe of the game, the adaptation of static graphical elements (case of the first two examples), the adaptation of the scenario and of the symbols for revealing the win of the digital game, etc.

According to particular embodiments, said obtaining is performed by optically reading an additional information printed on the card. The additional information may be an extension of a logistical identifier of the card. The logistical identifier is for example printed on the card in the form of numbers and/or of a barcode, or of any other representation readable by an optical reading system.

Still according to particular embodiments, said obtaining is performed by consulting, from a logistical identifier of the card, a database associating contextual elements to the cards.

Still according to particular embodiments, the method further comprises an additional contextual adaptation of said additional game identified according to at least one external criterion. The external criterion may in particular be the place, the date and/or the time of purchasing the card, or of accessing the additional game.

Another object of the invention is a device comprising a processing unit configured to execute each of the steps of the method described above as well as a game system comprising such a device and a range of game cards associated with a main game, each game card comprising a contextual element of a plurality of contextual elements associated with the main game, at least two distinct cards from the range of cards comprising two distinct contextual elements and at least two distinct cards from the range of cards comprising the same contextual element.

Another aim of the invention is a computer program including instructions for implementing the method described above, or certain parts of this method, when this program is executed by a computer.

This program may use any programming language (for example, an object language or other), and be in the form of an interpretable source code, a partially compiled code or a fully compiled code.

Another aspect relates to a non-transitory storage medium of a computer executable program, comprising a dataset representing one or more programs, said one or more programs comprising instructions for, during the execution of said one or more programs by a computer comprising a processing unit optionally coupled to memory means and to an input/output interface module, for executing all or part of the method described above.

### BRIEF DESCRIPTION OF THE DRAWINGS

Other features, details and advantages of the invention will become apparent upon reading the following description. This description is purely illustrative and must be read with regard to the appended drawings wherein:

FIG. 1 illustrates an example of an environment wherein the invention may be implemented according to particular embodiments;

FIG. 2 illustrates an example of a scratchcard on the front side when the masks have not been removed (a), on the back side (b) and on the front side when the masks have been removed (c);

FIG. 3 illustrates a first example of a range of three different cards of the same scratchcard game;

FIG. 4 illustrates a second example of a range of three different cards of the same scratchcard game;

FIG. 5 illustrates a first example of steps for proposing an additional game to a player, the additional game being customised according to the features of a game card;

FIG. 6 illustrates a second example of steps for proposing an additional game to a player, the additional game being customised according to the features of a game card;

FIG. 7 illustrates an example of steps of a method for contextual adaptation of an additional game according to particular embodiments of the invention; and

FIG. 8 illustrates an example of device that can be used to implement, at least partially, embodiments of the invention, in particular steps described with reference to FIGS. 5 to 7.

### DETAILED DESCRIPTION

According to particular embodiments of the invention, a card of a scratchcard game may make it possible to adapt an additional digital game to one or more contextual elements carried by the card considered. The experience of the additional game is thus contextualised. Contextual element in particular means a selection by the player when purchasing the card (for example selection of an astrological sign in the context of an “Astro” scratchcard game or selection of a number in the context of the “Lucky number” or “Favourite number” game) or also a game element associated with the card and revealed during scratching. The additional game experience thus offers the possibility of diversifying, contextualising or even customising the experience of the player, by adapting the digital game to a particular contextual element.

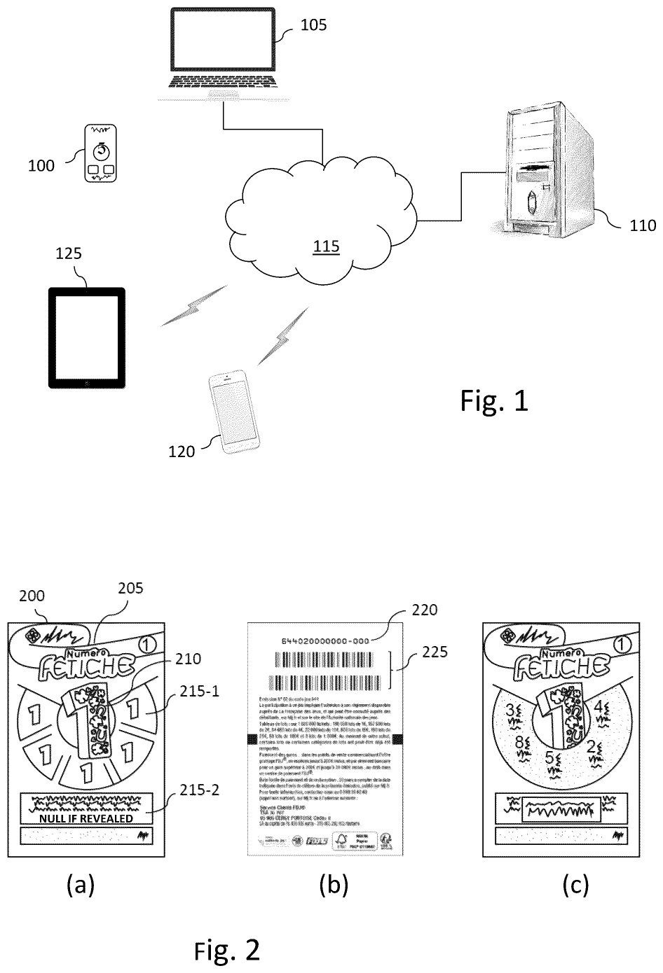

FIG. 1 illustrates an example of an environment wherein the invention may be implemented according to particular embodiments. As shown, a user can purchase a physical game card 100, for example in a point of sale (POS). Typically, it comprises a logistical identifier and a validation code. The validation code is used to know if the player has won or not and to determine a status. By way of illustration, after being validated, a card may be in a payable, already paid or blocked state, for example if it has been declared stolen.

In order to obtain the payment of any prizes, the player may go to a point of sale provided with a terminal 105 connected to a server 110 of the manager of the game considered, via a communication network 115. The terminal 105 comprises input means such as a keyboard or read means such as a scanner to obtain the validation code of a card. It also comprises means for sending requests to the server 110, in particular requests comprising card validation codes. Thus, after reading the identifiers or codes of a card, the terminal 105 sends a request to the server 110, comprising the logistical identifier and the validation code, in order to know the amount of the win and the status of the card. In response, the terminal receives the win and status information. Where applicable, the point of sale can then pay the wins to the player.

Moreover, a player can use a personal device, for example a smartphone 120, a tablet 125 or a personal computer (not shown) to access an additional digital game of the scratchcard game. For these purposes, they may use a specific application or a web interface. According to particular embodiments, the additional game modifies the win carried by the scratchcard considered, for example to add a win, monetary or in kind, to an initially winning or losing card or to partially or totally reduce the win carried by the card. It may concern, for example, an interactive game of the double or quits type.

Indeed, after transmitting the result of the card considered, or simultaneously, the server 110 may transmit an indication according to which an option is offered to the player, holder of the card considered, of participating in a second game, also called add-on or additional game. It may concern, for example, an interactive game of the “double or quits” type, or a draw game of the “second chance” type. The player can then start the interactive game or confirm their participation in the second draw game using the specific application or the web interface. Such an option may also be offered to a player at a point of sale. According to particular embodiments, the start of the interactive game or the registration of the participation of a player in a second game is carried out automatically, when a player consults their card on the specific application or the web interface.

According to embodiments of the invention, certain parameters of the second game are determined depending on a contextual element associated with the card considered, thus customising the second game depending on said contextual element. It may concern, for example, in the context of a scratchcard game having the theme of astrology, the sign of the zodiac printed on the card. It may also concern, for example a symbol revealed after scratching related to the universe of the game.

FIG. 2 illustrates an example of a scratchcard on the front side when the masks have not been removed (a), on the back side (b) and on the front side when the masks have been removed (c). As illustrated, here the card 200 comprises a graphical reference 205 to the game for which the card has been published, here the “Favourite Number” game, a contextual element 210 here corresponding to the favourite number “1” as well as scratch areas, for example the scratch areas 215-1 and 215-2. As indicated, scratching the masking area 215-2 cancels the card. The back of the card comprises for example an extract of the rules of the game as well as references, for example a card number 220 and corresponding barcodes 225. The contextual element is an integral part of the scratch experience and of the graphical representation of the card. In order to be used in the context of an additional digital game, the contextual element must be accessible to the application of the player and to the gaming platform. Its value may be printed on the card, for example in an extension of the logistical code, or saved in the central game system as an additional attribute of the card.

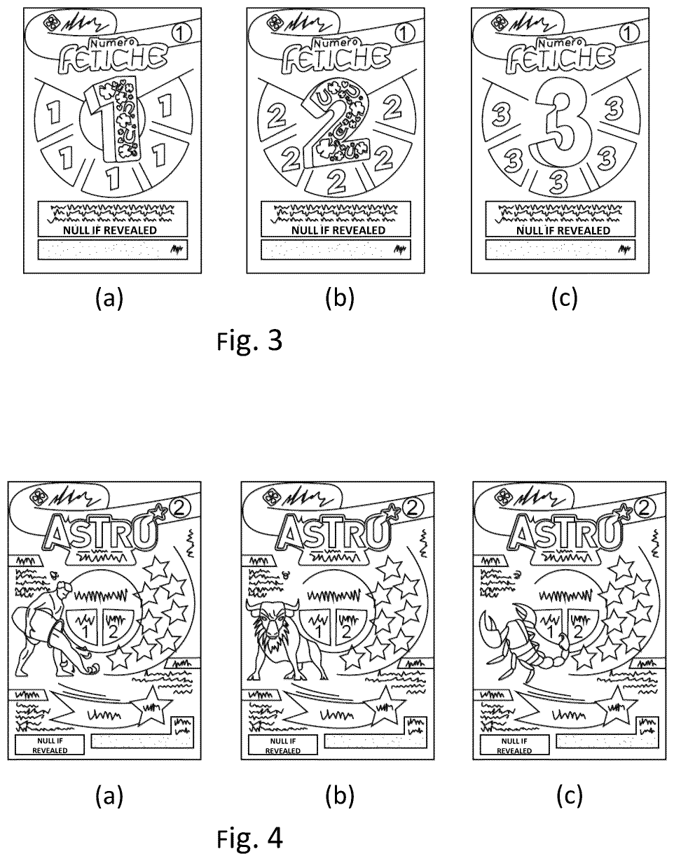

FIG. 3 illustrates a first example of a range of three different cards of the same scratchcard game. As illustrated, it concerns the “Favourite Number” scratchcard game described with reference to FIG. 2. The first card (card a) has a contextual element corresponding to the favourite number “1”, the second card (card b) has a contextual element corresponding to the favourite number “2” and the third card (card c) has a contextual element corresponding to the favourite number “3”. These three cards make it possible to play the same main game, here the “Favourite Number” scratchcard game, and, in accordance with embodiments of the invention, additional games customised in different ways.

FIG. 4 illustrates a second example of a range of three different cards of the same scratchcard game. As illustrated, this concerns the “Astro” scratchcard game. The first card (card a) has a contextual element corresponding to the “Virgo” sign, the second card (card b) has a contextual element corresponding to the “Taurus” sign and the third card (card c) has a contextual element corresponding to the “Scorpio” sign. These three cards make it possible to play the same main game, here the “Astro” scratchcard game, and, in accordance with embodiments of the invention, additional games customised in different ways.

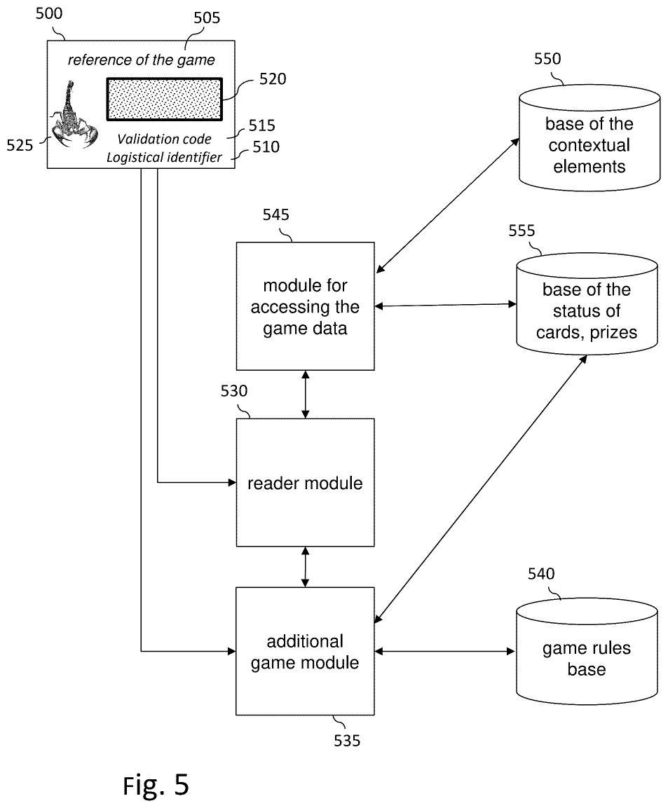

FIG. 5 illustrates a first example of steps for proposing an additional game to a player, this additional game being customised according to the features of a game card belonging to a range of cards. According to this first example, a scratchcard 500 comprises graphical elements relating to the game, graphical elements relating to a contextual element of the game, one or more scratch areas, a logistical identifier and a validation code. Thus, for example, the card 500 in particular comprises a game reference 505, a logistical identifier 510, a validation code 515, a scratch area 520 and a graphical element 525 relating to a contextual element. The logistical identifier 510 is for example printed in the form of letters and/or of numbers. Alternatively or additionally, it may be printed in the form of barcodes and/or QR codes. It is observed that according to the embodiment described here, the graphical element 525 relating to a contextual element is not used as such to contextualise the additional game. However, this element can be used by the player to select the card.

According to the example illustrated in FIG. 5, the logistical identifier 510 and the validation code 515 are obtained by an optical reader module 530 or via a manual input module, for example using a physical or virtual keyboard on a touch screen.

After verifying a card, the holder of the card here can access an additional game through an additional game module 535. This additional game module 535 is for example an application executed on a server of the organiser of the game, remotely accessible by a personal device such as a smartphone or a tablet, or by a computer located in a point of sale. According to particular embodiments, this game module may also be downloaded and executed on a personal device. Access to this additional game may be proposed automatically on the device used to activate the card, after activation, or may be given to the holder of the card at their request. This additional game is defined by parameters that here are stored in a database 540. These parameters comprise at least one card contextual element, for customising the additional game.

By way of illustration, if the additional game is an interactive game, the contextual element obtained by the additional game module 535 can be used to define a parameter of the game, for example a graphic environment of the additional game, or to modify the information displayed to the player, adapt the context from which the game is executed or the choices that are proposed to them.

The contextual element of the card is obtained here from the central system from the logistical identifier 510 thanks to an access module 545 connected to a database 550 that establishes a link between logistical identifiers and contextual elements. The database 550 is constructed during the generation of the cards. An example of such a database is presented in the appendix, in the form of a table (Table 1) associating contextual elements with card numbers. By way of illustration, the contextual element having the value “1” is associated with the cards carrying the logistical identifiers “0123456789”, “1063285412” and “6893617531”.

According to a particular embodiment, the additional game module 535 queries the reader module 530 that transmits the logistical identifier 510 to the access module 545. The latter, after obtaining the contextual element of the card from the database 550, transmits this contextual element to the reader module 530 that in turn transmits it to the additional game module 535. The contextual element received is then used as a parameter of the game rules obtained from the database 540 and used by the additional game module 535. Alternatively, a code other than the logistical identifier may be used to find the contextual element.

It is observed here that one or more external criteria can be used to define other contextual elements, in order to increase the variety of the additional games. Such external criteria are, for example, the place, the date and/or the time of purchasing the card, or of accessing the additional game via the player application.

According to the example illustrated, the status of the cards is stored in a database 555.

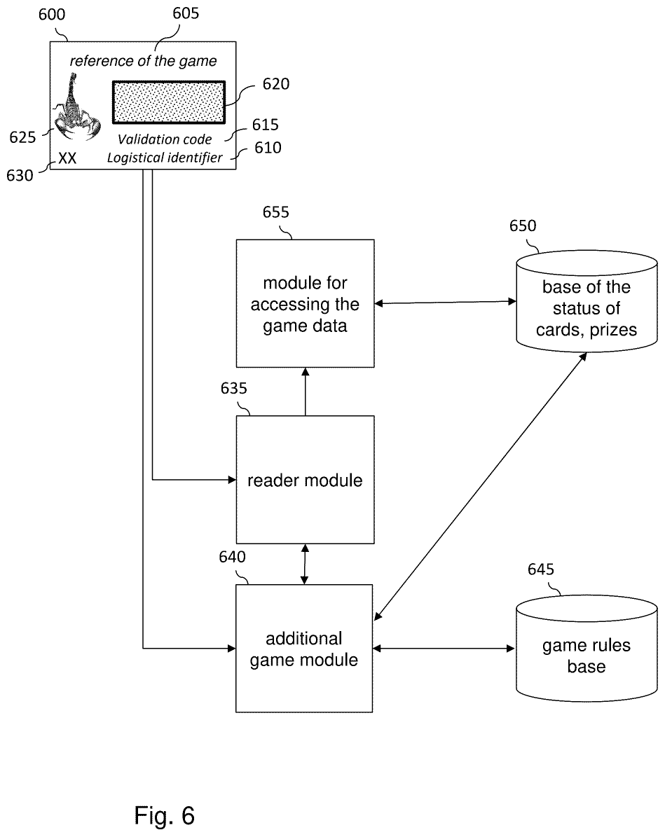

FIG. 6 illustrates a second example of steps for proposing an additional game to a player, the additional game being customised according to the features of a game card.

As in the example described with reference to FIG. 5, a scratchcard 600 comprises graphical elements relating to the game, graphical elements relating to a contextual element of the game, one or more scratch areas, a logistical identifier, a validation code and additional information. The latter may form part of the logistical identifier or of the validation code, may be independent and disposed at a predetermined location or may be independent and identifiable using predetermined graphical indicators. It makes it possible to obtain the contextual element of the additional game. Thus, for example, the card 600 in particular comprises a game reference 605, a logistical identifier 610, a validation code 615, a scratch area 620, a graphical element 625 and additional information 630 relating to a contextual element. The logistical identifier 610, the validation code 615 and/or the additional information 630 are for example printed in the form of letters and/or of numbers. Alternatively or additionally, they may be printed in the form of barcodes and/or QR codes. Once again, the graphical element 625 relating to a contextual element is not used here as such to contextualise the additional game.

According to the example illustrated in FIG. 6, the logistical identifier 610, the validation code 615 and the additional information 630 are obtained by an optical reader module 635 or via a manual input module, for example using a physical or virtual keyboard on a touch screen.

After verifying a card, the holder of the card here can access an additional game through the additional game module 640. Once again, this additional game module is for example an application executed on a server of the organiser of the game, remotely accessible by a personal device such as a smartphone or a tablet, or by a computer located in a point of sale. According to particular embodiments, this game module may also be downloaded and executed on a personal device. Access to this additional game may be proposed automatically on the device used to activate the card, after activation, or may be given to the holder of the card at their request. This additional game is defined by parameters that here are stored in a database 645. These parameters comprise at least one card contextual element, for customising the additional game.

By way of illustration, if the additional game is an interactive game, the contextual element obtained by the additional game module 640 can be used to define a parameter of the game, for example a graphic environment of the additional game to define a parameter of the game, for example a graphic environment of the additional game, or to modify the information displayed to the player, adapt the context from which the game is executed or the choices that are proposed to them.

As indicated above, here the card comprises a representation of a contextual element readable by the reader module 635. This indication may be independent (e.g. additional information 630) or be integrated into the logistical identifier or into the validation code, for example in the form of additional characters, for example two additional numbers for attributing up to 100 contextual elements to a set of cards. This representation of the contextual element is directly interpretable by the reader module 635 or by the additional game module 640 after this representation of the contextual element has been transmitted to it.

Once again, it is observed here that one or more external criteria can be used to define other contextual elements, in order to increase the variety of the additional games. Such external criteria are, for example, the place, the date and/or the time of purchasing the card, or of accessing the additional game via the player application.

It is further observed here that although the contextual element indication may be in the form of a specific code that can be read directly on the card described with reference to FIG. 6, in another embodiment, this indication may be obtained differently, for example by analysing images to identify a graphical element representing the attribute or the genre, for example the graphical element 625 in FIG. 6, or by reassigning an existing code on the cards.

As in the example illustrated in FIG. 5, a database 650, accessible by the additional game module 635 and by a module for accessing the game data 655, is in particular used to store the status of the cards and/or to obtain it.

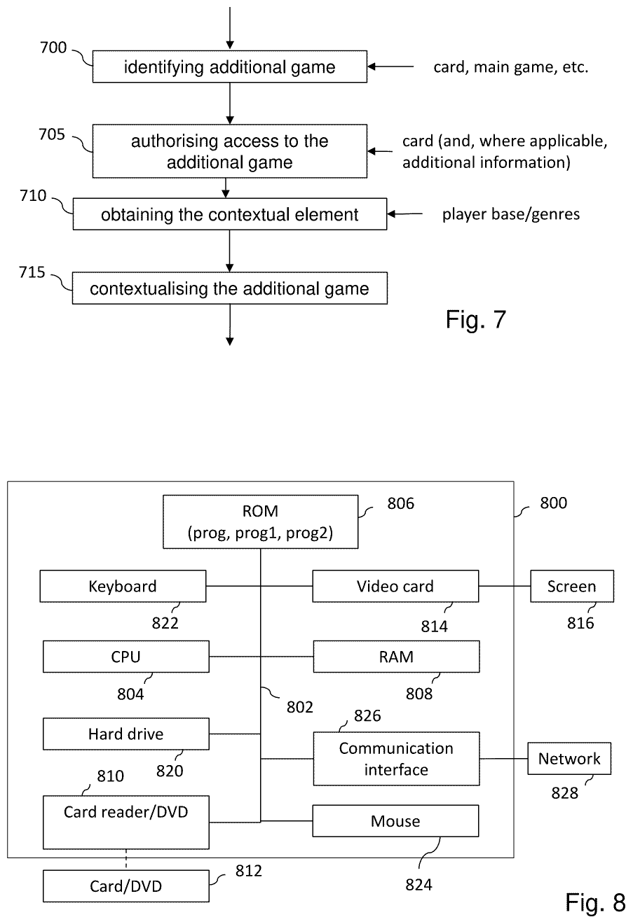

FIG. 7 illustrates an example of steps of a method for contextual adaptation of an additional game according to particular embodiments of the invention.

As illustrated, the purpose of a first step (step 700) is to identify an additional game associated with a scratchcard. The additional game may be identified from the card itself or, for example, from the logistical identifier.

Access to the additional game is then authorised to the holder of the card considered (step 705).

In a following step, the contextual element of the card is obtained (step 710). As described above, in particular with reference to FIGS. 5 and 6, this contextual element can be obtained directly from the card by reading a specific indication (example described with reference to FIG. 6), for example a textual, coded or graphical indication or indirectly, for example from the logistical identifier of the card, by accessing a database associating contextual elements with cards (example described with reference to FIG. 5).

The additional game identified is then contextualised (step 715). According to the additional game identified, the contextual adaptation may comprise a step of determining a graphic environment of the game to make it possible to start the interactive game.

FIG. 8 illustrates an example of device that can be used to implement, at least partially, embodiments of the invention, in particular steps described with reference to FIGS. 5 to 7.

The device 800 is for example a server, a computer or a terminal.

The device 800 preferably includes a communication bus 802 to which are connected:
a central processing unit 804 (CPU);
a read only memory 806 (ROM) that may include the operating system and programs such as “Prog”;
a random access memory 808 (RAM) including registers adapted to save variables and parameters created and modified during the execution of the aforementioned programs; and
a communication interface 826 connected to a distributed communication network 828, for example a wireless communication network and/or a local communication network, the interface being capable of transmitting and receiving data, in particular to and from a device of a user.

Optionally, device 800 may also have the following elements:
a hard drive 820 that may include the aforementioned programs “Prog” and data processed or to be processed according to the invention;
a keyboard 822 and a mouse 824 or any other pointing device such as an optical stylus, a touch screen or a remote control that makes it possible for the user to interact with the programs according to the invention;
a reader 810 of a removable storage medium 812 such as a memory card or a disc, DVD disc; and
a graphics card 814 connected to a screen 816.

The communication bus enables the communication and the interoperability between the various elements included in the device 800 or connected to it. The representation of the bus is not limiting and, in particular, the central processing unit is likely to communicate instructions to any element of the device 800 directly or by means of another element of the device 800.

The executable code of each program making it possible for the programmable device to implement the processes according to the invention may be stored, for example, in the hard drive 820 or in the read only memory 806.

According to an alternative embodiment, the executable code of the programs may be received by means of the communication network 828, via the interface 826, to be stored in a manner identical to that described above.

More generally, the program(s) may be loaded into one of the storage means of the device 800 before being executed.

The central processing unit 804 will control and direct the execution of the instructions or portions of software code of the program(s) according to the invention, instructions that are stored in the hard drive 820 or in the read only memory 806 or in the other aforementioned storage elements. When powering on, the program(s) that are stored in a non-volatile memory, for example the hard drive 820 or the read only memory 806, are transferred into the random access memory 808 that then contains the executable code of the program(s) according to the invention, as well as registers for storing the variables and parameters necessary for implementing the invention.

Depending on the embodiment chosen, certain acts, actions, events or functions of each of the methods described in the present document may be carried out or occur according to an order different to that in which they have been described, or may be added, merged or even not be carried out or not occur, depending on the case. Furthermore, in certain embodiments, certain acts, actions or events are carried out or occur concurrently and not successively.

Although described through a certain number of detailed embodiments, the method proposed and the equipment for implementing the method comprise various alternative embodiments, modifications and improvements that will become apparent to the person skilled in the art, it being understood that these various alternative embodiments, modifications and improvements fall within the scope of the invention, such as defined by the following claims. In addition, various aspects and features described above may be implemented together, or separately, or substitute one another, and all of the various combinations and subcombinations of the aspects and features fall within the scope of the invention. Furthermore, it may be that certain systems and equipment described above may not incorporate all of the modules and functions described for the preferred embodiments.

TABLE 1

| Contextual element | Card number |
|---|---|
| 1 | 0123456789 |
| | 1063285412 |
| | 6893617531 |
| . . . | . . . |
| i | 7426405217 |
| | 1231675455 |
| . . . | . . . |

1. Method for contextual adaptation of games in a game system comprising at least one data processing device and a range of physical game cards associated with a main game, each game card comprising a contextual element associated with the main game, at least two distinct cards from the range of cards comprising two distinct contextual elements and at least two distinct cards from the range of cards comprising the same contextual element, the method being implemented in the at least one device and comprising, for at least one card from the range of cards,
identifying an additional game depending on at least one indication of said at least one card;
authorising access to said additional game to a holder of said at least one card;
obtaining the contextual element of said at least one card; and
adapting, according to said obtained contextual element, said identified additional game, said contextualised additional game being specific to said obtained contextual element.

2. Method according to claim 1, according to which said obtaining is performed by optically reading additional information printed on the card.

3. Method according to claim 2, according to which the additional information is an extension of a logistical identifier of the card.

4. Method according to claim 3, according to which the logistical identifier is printed on the card in the form of numbers and/or of a barcode, or of any other representation readable by an optical reader system.

5. Method according to claim 1, according to which said obtaining is performed by consulting, from one logistical identifier of the card, a database associating contextual elements to the cards.

6. Method according to claim 1, further comprising an additional contextual adaptation of said additional game identified according to at least one external criterion.

7. Method according to claim 6, according to which the external criterion is the place, the date and/or the time of purchasing the card or accessing the additional game.

8. Computer program comprising instructions for implementing each of the steps of the method according to claim 1, when said program is executed by a processor.

9. Device comprising a processing unit configured to execute each of the steps of the method according to claim 1.

10. Game system comprising the device according to claim 9 and a range of game cards associated with a main game, each game card comprising a contextual element of a plurality of contextual elements associated with the main game, at least two distinct cards from the range of cards comprising two distinct contextual elements and at least two distinct cards from the range of cards comprising the same contextual element.
